(19) United States
(12) Patent Application Publication
(10) Pub. No.: US 2017/0174091 A1
(43) Pub. Date: Jun. 22, 2017

(54) UNMANNED AERIAL VEHICLE BATTERY REPLACEMENT ARM

(71) Applicant: Skycatch, Inc., San Francisco, CA (US)

(72) Inventors: Samuel Giles Miller, Folsom, CA (US); Anthony Gomez, El Dorado Hills, CA (US); Jonathan Shyaun Noorani, Orangevale, CA (US)

(21) Appl. No.: 14/971,738

(22) Filed: Dec. 16, 2015

(51) Int. Cl. B60L 11/18; B64F 1/36; B64C 39/02

(52) U.S. Cl. CPC B60L 11/1822; B60L 11/1827; B60L 11/1824; B64C 39/024; B64F 1/36; B64C 2201/042

(57) ABSTRACT

The present disclosure is directed toward systems and methods for removing and replacing a battery from within an unmanned aerial vehicle (UAV). In particular, systems and methods described herein enable a battery arm within a UAV ground station (UAVGS) to engage the UAV and a battery assembly within the UAV to unlock the battery assembly and remove the battery assembly from within the UAV. For example, the battery arm can include a latch engagement assembly that engages one or more latches on the UAV to unlock the battery assembly. Additionally, the battery arm can include a battery gripping assembly that grips an outer end of the battery assembly while retracting and removing the battery assembly from within the UAV.

### BACKGROUND

1. Technical Field

One or more embodiments of the present disclosure generally relate to a battery arm. More specifically, one or more embodiments relate to a battery arm within an unmanned aerial vehicle ground station (UAVGS) that engages with, removes, and replaces a battery from within an unmanned aerial vehicle (UAV).

2. Background and Relevant Art

Aerial photography and videography are becoming increasingly common in providing images and videos in various industries. For example, aerial photography and videography provides tools for construction, farming, real estate, search and rescue, and surveillance. In recent years, UAVs have provided an improved economical approach to aerial photography and videography compared to capturing photos and videos from manned aircraft or satellites.

Conventional UAVs typically include batteries that power various systems within the UAV. For example, UAVs often include one or more batteries that provide power to rotors, cameras, or other systems on board the UAV. Nevertheless, while batteries provide a light and convenient power source for UAVs, batteries are often limited in the amount and duration of power that they provide to the UAV. As such, the distance and duration that a UAV can fly and perform various tasks is limited by battery life.

In some circumstances, UAVs extend range of flight by landing and taking off from remote ground stations (e.g., UAVGSs). Use of remote ground stations, however, causes various complications in recharging and/or replacing batteries from within the landed UAVs. For example, a UAV or UAVGS operator typically travels to the remote ground station and manually removes and replaces a battery when the battery ceases to work or when the battery otherwise needs replacement. Performing remote maintenance on the UAV and/or UAVGS, however, results in considerable expense. In particular, the time and expense required to train an operator and to travel to the remote ground station is cost prohibitive to many companies that benefit from the use of UAVs.

Additionally, UAVs often secure batteries within the UAVs by locking or otherwise securing the batteries within the UAV. For example, a battery is often locked within the UAV to prevent the UAV from accidentally slipping out of the UAV. While locking the battery within the UAV prevents the battery from slipping out, securing the battery using a lock increases the complexity of removing the battery from within the UAV. Additionally, frequently engaging a locking mechanism often causes wear and tear on a battery and/or the UAV. As such, UAVs that include locking mechanisms often result in increased operator maintenance and additional wear and tear on the battery and/or UAV.

Accordingly, there are a number of considerations to be made in removing and/or replacing a battery from within a UAV.

### BRIEF SUMMARY

The principles described herein provide benefits and/or solve one or more of the foregoing or other problems in the art with systems and methods that enable autonomous replacement of a battery from within an unmanned aerial vehicle (UAV). In particular, one or more embodiments described herein include a battery arm within an unmanned aerial vehicle ground station (UAVGS) that engages with and conveniently removes a battery assembly from a UAV. For example, one or more embodiments include a UAVGS having a battery arm that automatically removes and replaces a battery assembly of a UAV.

In particular, when the UAV lands within the landing housing of the UAVGS, the battery arm can engage with the UAV and a battery assembly to remove the battery assembly from within a receiving slot on the UAV. Additionally, the battery arm can insert a new battery assembly within the receiving slot on the UAV. As such, the UAVGS can autonomously replace a battery assembly of UAV and enable multiple flights without frequent operator maintenance.

Furthermore, in one or more embodiments, systems and methods include features and functionality that enable the battery arm to autonomously unlock a battery assembly secured within a receiving slot of a UAV. For example, in engaging the UAV, the battery arm can include one or more latch engagers that engage one or more latches on the UAV and cause the battery assembly to unlock from within the UAV. Once unlocked, the battery arm can include one or more battery grippers that grip a portion of the battery assembly and conveniently retract the unlocked battery from within the UAV.

Additional features and advantages of exemplary embodiments will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the embodiments can be obtained, a more particular description of the principles briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of its scope, principles will be described and explained with additional specificity and detail through the use of the accompanying drawings.

FIG. 1 illustrates a side-perspective view of an example unmanned aerial vehicle ground station in accordance with one or more embodiments;

FIG. 2 illustrates a side-perspective view of an example unmanned aerial vehicle in accordance with one or more embodiments;

FIG. 3 illustrates a perspective view of a battery arm in accordance with one or more embodiments;

FIG. 4 illustrates a top view of a portion of a battery arm in accordance with one or more embodiments;

FIG. 5 illustrates a perspective view of a battery assembly within a receiving slot of an unmanned aerial vehicle in accordance with one or more embodiments;

FIG. 6A illustrates a top cross-sectional view of an example battery arm engaging latches of an unmanned aerial vehicle to unlock a battery assembly within the unmanned aerial vehicle in accordance with one or more embodiments;

FIG. 6B illustrates a top cross-sectional view of an example battery arm engaging a battery assembly within an unmanned aerial vehicle in accordance with one or more embodiments;

FIG. 6C illustrates a top cross-sectional view of an example battery arm removing a battery assembly from within an unmanned aerial vehicle in accordance with one or more embodiments;

FIG. 7 illustrates a schematic diagram of an autonomous landing system in accordance with one or more embodiments;

FIG. 8 illustrates a flowchart of a series of acts in a method of autonomously replacing a battery assembly from within an unmanned aerial vehicle; and

FIG. 9 illustrates a block diagram of an exemplary computing device in accordance with one or more embodiments.

### DETAILED DESCRIPTION

One or more embodiments described herein relate to an autonomous landing system for an unmanned aerial vehicle. In particular, the autonomous landing system includes an unmanned aerial vehicle (UAV) that includes a main body and a replaceable battery assembly locked within the main body of the UAV. Additionally, the autonomous landing system includes an aerial vehicle ground station (UAVGS) that includes a landing housing that receives the UAV when the UAV lands within the UAVGS. Additionally, the UAVGS includes a battery arm that selectively engages and replaces the battery assembly.

In one or more embodiments, the UAVGS and associated battery arm reduces frequency of operator maintenance by enabling autonomous replacement of a battery assembly within a UAV. For example, when the UAV lands within the UAVGS, the battery arm selectively engages the UAV to unlock and remove the battery assembly from within the UAV. As such, the battery arm can autonomously engage the UAV and battery assembly to conveniently replace the battery assembly from within the UAV without requiring operator maintenance.

In addition to enabling convenient replacement of the battery assembly, one or more embodiments of the battery arm help reduce wear and tear on the battery assembly by engaging the UAV and battery assembly using multiple engagement assemblies on the battery arm. For example, the battery arm can include a latch engagement assembly and a batter gripping assembly. The latch engagement assembly engages one or more latches on the UAV to unlock the battery assembly from within the UAV. Once unlocked, a battery gripping assembly grips a portion of the battery assembly and allows the battery arm to remove the battery assembly from the UAV when the battery arm retracts away from the UAV. The latch assembly and gripping assembly enable the UAVGS to automatically remove the battery assembly from within the UAV.

In addition to separate engagement assemblies, one or more embodiments of the battery arm includes one or more sensors that prevent incidental contact between the battery arm and the UAV or battery assembly. For example, in one or more embodiments, the battery arm includes one or more sensors on an end of the battery arm facing the UAV. When the battery arm extends towards the UAV, the sensors detect a proximity of the battery arm with respect to the UAV and/or battery assembly and prevent the battery arm from inadvertently coming into contact with and potentially damaging the UAV, battery assembly, or other components of the autonomous landing system.

The term “unmanned aerial vehicle” (“UAV”), as used herein, generally refers to an aircraft that can be piloted autonomously or remotely by a control system. For example, a “drone” is a UAV that can be used for multiple purposes or applications (e.g., military, agriculture, surveillance, etc.). In one or more embodiments, the UAV includes onboard computers that control the autonomous flight of the UAV. In at least one embodiment, the UAV is a multi-rotor vehicle, such as a quadcopter, and includes a carbon fiber shell, integrated electronics, a battery bay (including a battery assembly), a global positioning system (“GPS”) receiver, a fixed or swappable imaging capability (e.g., a digital camera), and various sensors or receivers. The UAV can also include a computing device including programmed instructions that allow the UAV to takeoff, fly, and land autonomously.

The term “unmanned aerial vehicle ground station” (“UAVGS”), as used herein, generally refers to an apparatus from which a UAV can takeoff, and where the UAV can later land and be stored until its next flight. For example, the UAVGS can include a carbon fiber box containing a UAV storage area that functions as a takeoff area and/or a landing pad when the UAV is not being stored. In at least one embodiment, following the autonomous landing of the UAV, one or more systems of the UAVGS can recharge or swap-out one or more batteries of the UAV, download data (e.g., digital photographs, digital videos, sensor readings, etc.) collected by the UAV. In one or more embodiments, the UAVGS allows for wireless communication between the UAVGS and a server to transfer of data collected by the UAV and downloaded to the UAVGS to the server.

The term “battery arm,” as used herein, generally refers to a mechanical apparatus that engages a battery assembly and causes the battery assembly to remove from within a receiving slot of a UAV or battery docking station. For example, the battery arm can include a mechanical arm that extends and retracts. Additionally, the battery arm can include multiple actuators (e.g., motors), plates, rods, screws, pins, links, chains, sensors, pivot points, circuitry, and various assemblies that engage with the UAV and/or battery assembly to facilitate automatic removal and automatic replacement of a battery assembly.

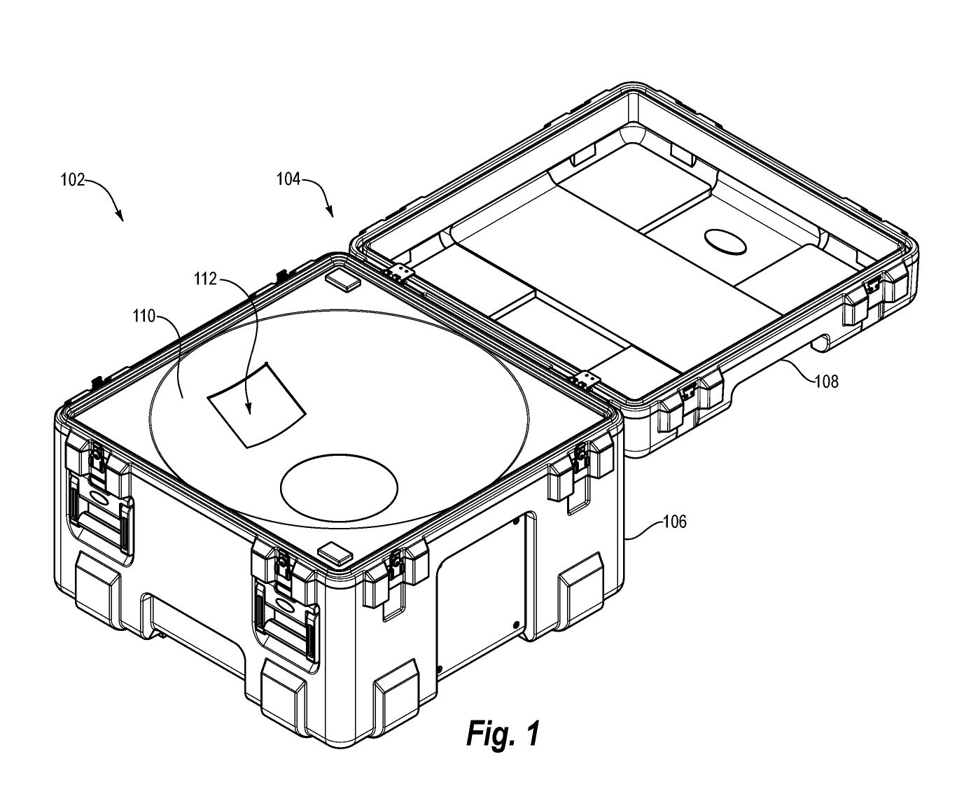

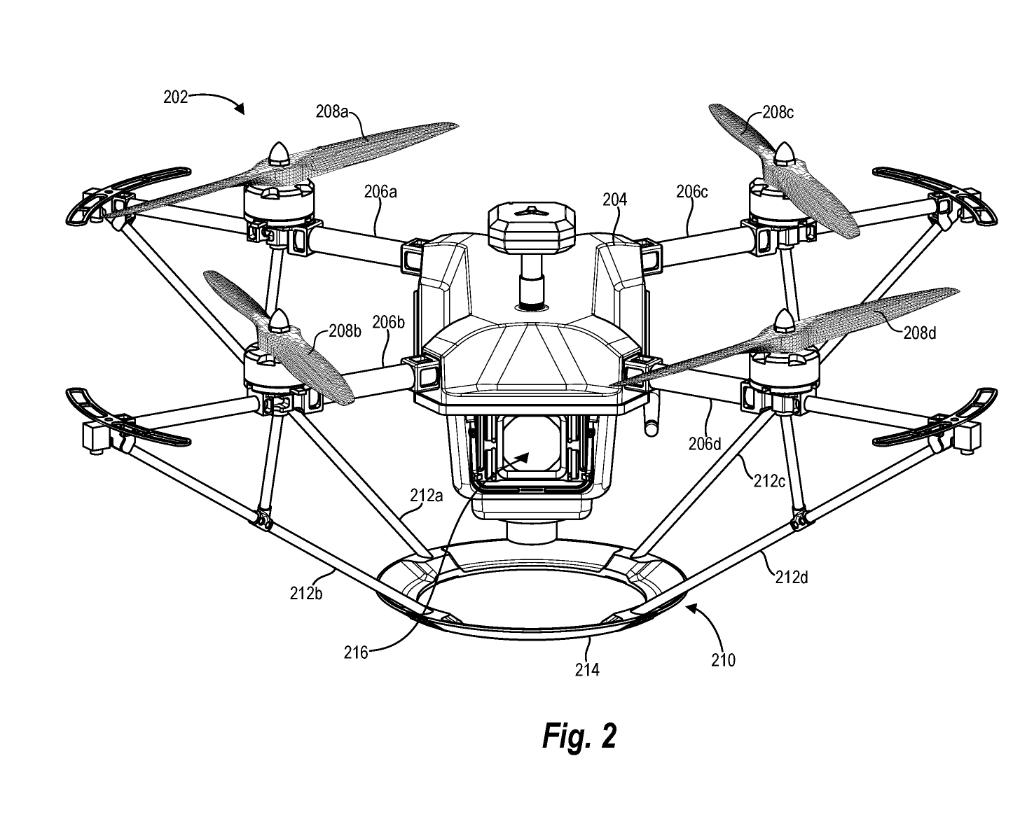

To aid in description of the battery arm and methods of using automatic battery assembly removal and replacement, an overview of an example unmanned aerial vehicle and ground station are first described with reference to FIGS. 1 and 2. One will appreciate that the configuration of the UAV and ground station are exemplary embodiments and the later described battery arm can function with a wide variety of UAVs, ground stations, and battery assemblies. FIGS. 1 and 2 illustrate perspective views of an unmanned aerial vehicle ground station 102 (or simply “UAVGS 102”) and an unmanned aerial vehicle 202 (or simply “UAV 202”) that lands within the UAVGS 102. For example, as shown in FIG. 1, the UAVGS 102 includes a housing 104 including a base 106 and a hinged lid 108. In one or more alternative embodiments, the UAVGS 102 can have a different shape or configuration. For example, the UAVGS 102 may lack a lid and include additional or alternative features.

Additionally, as illustrated in FIG. 1, the UAVGS 102 includes a landing housing 110. As shown in FIG. 1, the landing housing 110 includes an opening toward a top surface of the base 106 and a floor of the landing housing 110 that makes up a bottom surface of the landing housing 110. Further, as shown in FIG. 1, the landing housing 110 has a shape that extends downward and inward from the opening of the landing housing 110 at the top of the base 106 toward a circular floor of the landing housing 110. In one or more embodiments, the UAVGS 102 includes a single landing housing 110 shaped to receive a single UAV 202 within the UAVGS 102. Alternatively, the UAVGS 102 can include multiple landing housings 110 having similar or different shapes and sizes.

While FIG. 1 illustrates one example in which the landing housing 110 has a conical shape, it is appreciated that the landing housing 110 can have a variety of different shapes and sizes. In any event, in one or more embodiments, the landing housing 110 has a complimentary shape to a landing base of a UAV. As such, the UAV fits within the complimentary-shaped landing housing 110 when the UAV lands within the UAVGS 102. In one or more embodiments, the landing housing 110 includes a shape that enables the UAV to fit within the landing housing 110 and align within the landing housing 110. Additionally, in one or more embodiments, the landing housing 110 includes a shape (e.g., symmetrical shape) that slants downward and inward from the opening at the top of the base 106 toward the floor of the landing housing 110 to enable the UAV to self-align within the landing housing 110 as the UAV comes into contact with and lands within the UAVGS 102.

Additionally, as shown in FIG. 1, the UAVGS 102 further includes an opening 112 in a wall of the landing housing 110. In particular, the landing housing 110 can include one or more openings 112 through which a portion of a battery arm passes and engages the UAV and/or battery assembly on board the UAV. For example, as will be explained in greater detail below, the battery arm extends through the opening 112 and unlocks a battery assembly within the UAV. Once unlocked, the battery arm grips the battery assembly and removes the battery assembly from within the UAV. Additionally, in one or more embodiments, the battery arm replaces the removed battery assembly with a new (e.g., charged) battery assembly retrieved from within the UAVGS 102.

In one or more embodiments, rather than having an opening 112 in a wall of the landing housing 110, one or more embodiments of the landing housing 110 include a landing frame or landing housing without a wall that provides unobstructed access between the battery arm and a UAV landed within the UAVGS 102. For example, the landing housing 110 can include a frame structure that includes multiple portions through which the battery arm can extend to engage the UAV and remove a battery assembly from within the UAV.

In one or more embodiments, the UAVGS 102 includes a carousel feature that enables the landing housing 110 and/or UAV to rotate within the UAVGS 102 to align the UAV with respect to one or more battery arms within the UAVGS 102. For example, in one or more embodiments, the landing housing 110 rotates and aligns the opening 112 and/or battery arm with a portion of the UAV that houses the battery assembly such that the battery arm can engage the UAV and remove the battery assembly. As another example, in one or more embodiments, the UAVGS 102 causes the UAV to rotate (e.g., using the floor of the landing housing 110) and align the UAV with the opening 112 in the landing housing 110. Additionally, or alternatively, in one or more embodiments, the UAVGS 102 causes the battery arm to rotate within the UAVGS 102 to align with the opening 112 and the UAV 202.

Furthermore, the UAVGS 102 can include one or more engagement points that secure a UAV in place within the landing housing 110 of the UAVGS 102. In particular, the UAVGS 102 can include one or more components that hold, fasten, or otherwise secure the UAV within the landing housing 110. As an example, the UAVGS 102 can include one or more magnets, grooves, rails, or various mechanical components that secure the UAV in place within the UAVGS 102. Alternatively, in one or more embodiments, the UAV can include one or more components that secure the UAV within the landing housing 110 of the UAVGS 102. The ability to hold the UAV in place within the UAVGS 102 can aid in battery assembly re-movement and replacement as described below.

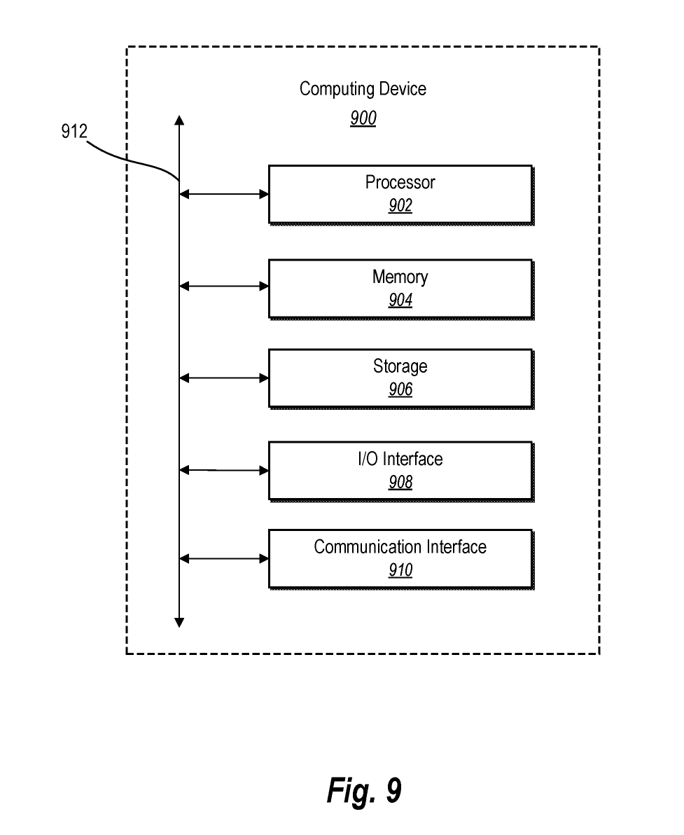

FIG. 2 illustrates an example UAV 202 in accordance with one or more embodiments described herein. As shown, the UAV 202 includes a main body 204 coupled to a plurality of rotor arms 206a-d that each support a respective rotor 208a-d. It will be understood that by varying the speed of the rotors 208a-d, the UAV 202 (e.g., a UAV controller on the UAV 202) can control the speed, direction, and altitude of the UAV 202. For example, the UAV 202 can control the speed of the rotors 208a-d in order to move the UAV 202 within a three-dimensional space. In additional or alternative embodiments, the UAV 202 may include fewer or additional rotor arms and rotors, depending on various factors such as the weight of the UAV 202. Additionally, as discussed above, the UAV 202 can include a computing device, such as described below with reference to FIG. 9, to use for controlling the UAV 202 based on input provided from one or more sensors.

As illustrated in FIG. 2, the UAV 202 includes a landing base 210 coupled to the main body 204 of the UAV 202. In particular, in one or more embodiments, the landing base 210 is connected to and positioned below the main body 204 of the UAV 202. As shown in FIG. 2, the landing base 210 includes a landing frame including legs 212a-d. Each of the legs 212a-d can correspond to respective rotor arms 206a-d. It is appreciated that the landing frame can include any number of legs 212. Alternatively, the landing frame includes a single structure or shell that extends around the landing base 210 (e.g., around a central axis of the UAV 202) and couples a landing pad 214 to the rotors 208 and main housing 204. In one or more embodiments, a shape formed by the legs 212a-d of the landing frame corresponds to the landing housing 110 of the UAVGS 102. For example, the landing frame can form a complimentary conical shape to the conically-shaped landing housing 110 shown in FIG. 1.

Additionally, as shown in FIG. 2, the landing base 210 includes a landing pad 214 positioned below the main body 204 of the UAV 202. In one or more embodiments, the landing pad 214 includes a circular landing ring. For example, the landing pad 214 can include a circular landing ring that corresponds to a shape of the floor of the landing housing 110. Alternatively, the landing pad 214 can include different shapes other than those shown in FIG. 2. For example, the landing pad 214 may have an angular shape, oval shape, or any symmetrical or non-symmetrical shape that fits within the floor of the landing housing.

Additionally, as shown in FIG. 2, the UAV 202 includes a battery assembly 216 within the main body 204 of the UAV 202. For example, as will be described in greater detail below, the battery assembly 216 includes a battery cell within a battery housing that slides in and out of a receiving slot that receives the battery assembly 216 within the main housing 204 of the UAV 202. The battery assembly 216 provides power to any number of systems and components on board the UAV 202. For example, the battery assembly 216 provides power to the rotors 208a-d, a camera attached to the main body 204, and one or more electrical systems on board the UAV 202.

Additionally, as will be explained in greater detail below, the UAV 202 includes one or more latches that secure the battery assembly 216 within the receiving slot of the UAV 202. For example, when the battery assembly 216 is completely inserted within the receiving slot, one or more latches prevent the battery assembly 216 from sliding or falling out of the main housing 204. When removing the battery assembly 216, a battery arm of the UAVGS 102 engages the latches and unlocks the battery assembly. Once the battery assembly 216 is unlocked, the battery arm grips the battery assembly 216 and remove the battery assembly 216 from the receiving slot of the UAV 202.

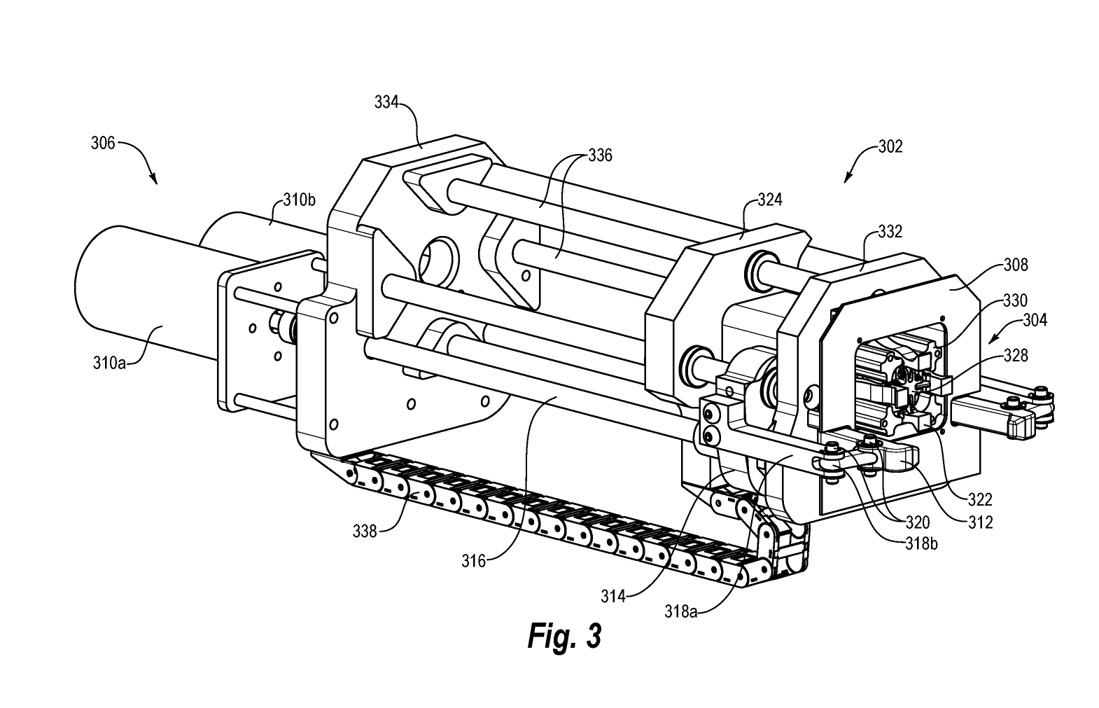

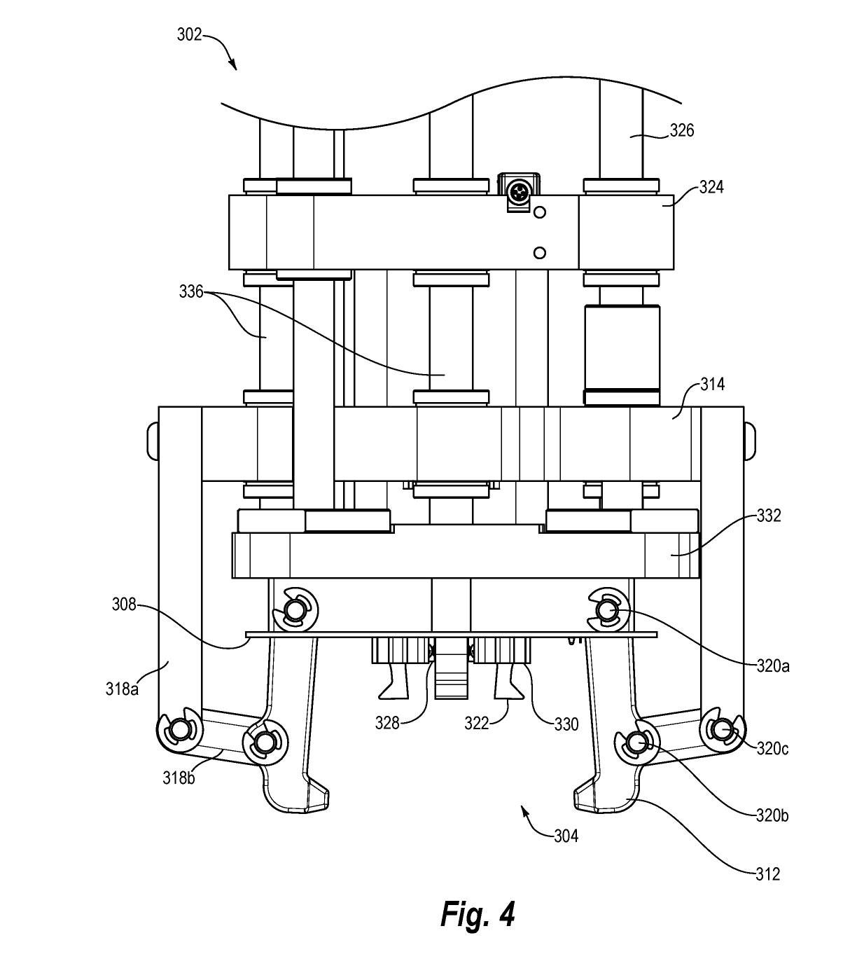

FIGS. 3 and 4 illustrate different views of an example battery arm 302 in accordance with one or more embodiments described herein. As mentioned above, the battery arm 302 can remove and replace a battery assembly 216 from within the main housing 204 of the UAV 202 when the UAV 202 is landed within a UAVGS 102. Prior to removing the battery assembly 216, the battery arm 302 aligns with the battery assembly 216 such that a first end 304 of the battery arm 302 is facing the UAV 202 and a second end 306 of the battery arm 302 is facing outward from the UAV 202 (e.g., toward the housing 104 of the UAVGS 102).

In addition to aligning the battery arm 302 with respect to the UAV 202 and/or battery assembly 216, a portion of the battery arm 302 moves or extends toward the UAV 202. For example, the first end 304 of the battery arm 302 moves toward the UAV 202. In one or more embodiments, the battery arm 302 moves toward the UAV 202 until an end plate 308 or other portion of the first end 304 of the battery arm 302 is within a predefined proximity of the UAV 202 or an end of the battery assembly 216. For example, the UAVGS 102 causes the battery arm 302 to move towards the UAV 202 until the first end 304 of the battery arm 302 is close enough to the UAV 202 that one or more components of the battery arm 302 are able to engage the UAV 202 and/or battery assembly 216.

In one or more embodiments, the battery arm 302 engages one or more latches on a UAV 202 to unlock a battery assembly 216 from within the main housing 204 of the UAV 202. In particular, the battery arm 302 includes a latch engagement assembly that includes one or more actuators that cause one or more latch engagers to come into contact with and engage one or more latches on the UAV 202. For example, as shown in FIG. 3, the latch engagement assembly includes a motor 310a, outer fingers 312, a latch engagement plate 314 (or simply “plate 314”), a driving rod 316, links 318a-b, and one or more pivot points 320 around which portions of the outer fingers 312 rotate. Additionally, FIG. 4 illustrates a view of the first end 304 of the battery arm 302 showing the plate 314, driving rod 316, links 318a-b, pivot points 320, and outer fingers 312.

As mentioned above, the latch engagement assembly can include an actuator, such as a motor 310a. As shown in FIG. 3, the motor 310a is positioned towards the second end 306 of the battery arm 302 and coupled to the outer fingers 312 via a driving rod 316, plate 314, and links 318a-b. While FIG. 3 illustrates one example embodiment of the battery arm 302 that includes a motor 310a, it is appreciated that the battery arm 302 can include various types of actuators such as, for example, hydraulic, pneumatic, electric, magnetic, or mechanical actuators and/or various types of motors capable of causing the outer fingers 312 to move and engage one or more latches on the UAV 202. Additionally, while FIG. 3 illustrates the motor 310a toward the second end 306 of the battery arm 302, it is appreciated that the motor 310a may be located anywhere between the first end 304 and second end 306 of the battery arm 302.

Further, as mentioned above, in causing a battery assembly 216 to unlock from within the UAV 202, the motor 310a causes the outer fingers 312 to rotate and engage with one or more latches on the UAV 202. In particular, the motor 310a can cause the outer fingers 312 to rotate toward the latches on the UAV 202 by driving the plate 314 toward the first end 304 of the battery arm 302 and causing the link 318 between the plate 314 and the outer fingers 312 to move towards the UAV 202. By causing the plate 314 and link 318 to move toward the UAV 202, the outer fingers 312 move about one or more pivot points 320 and rotate inward such that an edge of each of the outer fingers 312 engages with a respective latch on the UAV 202.

In driving the plate 314 towards the first end 304 of the battery arm 302, the motor 310a can cause the driving rod 316 to move and drive the plate 314 towards the UAV 202. In particular, as illustrated in FIG. 3, the driving rod 316 includes a threaded rod that spins and drives the plate 314 by causing the plate 314 to move towards the first end 304 of the battery arm 302 as the threaded driving rod 316 spins. Alternatively, rather than causing a threaded driving rod 316 to spin and drive the plate 314 towards the UAV 202, one or more embodiments of the latch engagement assembly can include a driving rod 316 that extends or otherwise moves to cause the plate 314 to move towards the first end 304 of the battery arm 302 and cause the outer fingers 312 to engage with latches on the UAV 202.

In addition to generally moving the plate 314 and outer fingers 312 towards the UAV 202, driving the plate 314 towards the UAV 202 further causes the outer fingers 312 to rotate about one or more pivot points 320. In particular, as shown in FIGS. 3 and 4, the latch engagement assembly includes a link 318a, 318b between the plate 314 and the outer fingers 312 that couples to the outer fingers 312 via one or more pivot points 320. As will be explained in greater detail below, when the motor 310a drives the plate 314 toward the UAV 202, one or more of the links 318a, 318b also move toward the UAV 202 and cause the outer ends of the outer fingers 312 to move towards the UAV 202 while rotating inward about one or more of the pivot points 320. In particular, when the link 318b moves toward the UAV 202, the movement of the link 318 causes the outer fingers 312 to rotate about one or more pivot points 320 and pivot inward about the first end 304 of the battery arm 302 and engage with latches on the UAV 202. In one or more embodiments, when the outer fingers 312 engage with the latches on the UAV 202, the battery assembly 216 unlocks from within the UAV 202.

In one or more embodiments, the battery gripping assembly utilizes over center linkage features when causing the outer fingers 312 to rotate inward about the one or more pivot points 320a-c. In particular, as shown in FIG. 4, the links 318a, 318b, and the outer finger 312 form an over center linkage. As explained below, the over center linkage can allow for fine tuning of the position of the finger 312 relative to a battery assembly. Additionally, the over center linkage can ensure that the finger 312 does not extend too far toward the battery assembly.

Thus, when the motor 310b causes the plate 314 to move towards the first end 304 of the battery arm 302 and cause the outer fingers 312 to rotate inward relative to the pivot points 320a-c at different rates based on a rotational position of the of the outer fingers 312 with respect to the pivot points 320a-c. For example, the outer fingers 312 can rotate more relative to a corresponding movement of the plate 314 or motor 310b when the outer fingers 312 extend outward from the central axis of the battery arm 302 (e.g., parallel to the outer plate 308) prior to engagement with the UAV 202 or battery assembly 216. Additionally, the outer fingers 312 can rotate less relative to the same movement of the plate 314 or motor 310b when the outer fingers 312 have rotated about the first pivot point 320a and approach an engagement position of the outer fingers 312 (e.g., perpendicular to the outer plate 308).

For example, as shown in FIG. 4, the motor 310b can drive the plate 314 toward the first end 304 of the battery arm 302 which would cause the second pivot point 320b and the third pivot point 320b to initially move toward the first end 304 and cause the outer fingers 312 to rotate about the first pivot point 320a. As the outer fingers 312 continue to rotate about the first pivot point 320a, the second pivot point 320b begins moving inward toward a central axis of the battery arm 302 while the third pivot point 320c continues to move towards the first end 304 of the battery arm 302. As the second pivot point 320b moves towards the central axis of the battery arm, the rate at which the outer fingers rotates about the first pivot point 320a slows relative to movement of the first pivot point 320a towards the first end 304 of the battery arm 302. Thus, as the outer fingers 312 approach an engagement position, the rotation of the outer fingers 312 can slow the rate at which the outer fingers 312 rotate relative to movement of the plate 314 toward the first end 304 of the battery arm 302.

In addition to causing the outer fingers 302 to rotate at different rates relative to movement of the motor 310b or plate 314, the over center linkage can prevent the outer fingers 302 from over-rotating beyond a maximum point of rotation. For example, as the outer fingers 312 rotate about the first pivot point 320a and the second pivot point 320b moves inward toward the central axis of the battery arm 302, the outer fingers 312 reach a maximum rotation about the first pivot point 320a notwithstanding continued movement of the first pivot point 320a toward the first end 304 of the battery arm 302. Thus, the battery arm 302 can drive the plate 314 beyond a point of engagement without causing the outer fingers 312 to continue rotating about the first pivot point 320a and risking damage to the battery assembly 216, UAV 202, or blocking a path for removing or inserting a battery assembly 216 within the UAV 202.

Additionally, or alternatively, in one or more embodiments, the battery arm 302 includes a stop, lock, or other feature that causes the outer fingers to stop rotating inward about the one or more pivot points 320a-c. As an example, the battery arm 302 can include a stop on one or more of the pivot points 320a-c or other portion of the battery arm 302 that prevents the outer fingers 312 from rotating beyond a specific point or angle. Similar to the over center linkage features discussed above, the stop, lock, or other feature the prevents rotation of the outer fingers 312 beyond a maximum rotation can prevent the outer fingers 312 from rotating inward to a point that could potentially damage one or more latches or springs on the UAV 202 or battery assembly 216 or obstruct a path for inserting or removing the battery assembly 216 from within the UAV 202.

Moreover, in one or more embodiments, one or more of the links 318a-b include compression and/or spring properties that cause the outer fingers 312 to apply a constant force to the UAV 202 when engaged with one or more latches on the UAV 202. For example, the first link 318a and/or second link 318b can include a spring that causes the outer fingers 312 to apply a force to one or more latches on the UAV 202 without further force applied via the motors 310b driving the plate 314 toward the UAV 202 beyond initial engagement between the outer fingers 312 and the UAV 202. In one or more embodiments, each of the links 318a-b include a spring or other compliant member that causes the outer fingers 312 to apply force on respective latches of the UAV 202. Alternatively, in one or more embodiments, only the first link 318a of the first and second links 318a-b includes a spring or other compliant member that causes the outer fingers 312 to apply force on respective latches of the UAV 202.

In addition to unlocking the battery assembly 216 from within the UAV 202, the battery arm 302 can further remove the battery assembly 216 from the UAV 202. For example, as shown in FIGS. 3-4, the battery arm 302 includes a battery gripping assembly that engages with the battery assembly 216 and grips a portion of the battery assembly 216 while removing the battery assembly 216 from the UAV 202. In particular, as illustrated in FIG. 3, the battery gripping assembly includes a motor 310b, inner fingers 322, a battery gripping plate 324 (or simply “plate 324”), a driving rod 326, a spreader 328, and optionally sensors 330. Additionally, FIG. 4 illustrates a view of the first end 304 of the battery arm 302 showing the inner fingers 322, plate 324, driving rod 326, spreader 328, and sensors 330.

Similar to the latch engagement assembly, the battery gripping assembly includes an actuator, such as a motor 310b. The motor 310b of the battery gripping assembly includes similar features and functionality as the motor 310a of the latch engagement assembly. In one or more embodiments, the motor 310b causes one or more battery grippers to engage a portion of the battery assembly 216 and grip an end of the battery assembly 216. For example, the motor 310b causes inner fingers 322 to engage a portion of the battery assembly 216 and grip the battery assembly 216. In one or more embodiments, the motor 310b causes the ends of the inner fingers 322 to move toward the outer fingers 312 and grip an end of the battery assembly 216. As will be explained in greater detail, once the inner fingers 322 have gripped a portion of the battery assembly 216, the battery arm 302 retracts and removes the unlocked battery assembly 216 from within the UAV 202.

Further, as mentioned above, in causing the inner fingers 322 to engage with and grip the battery assembly 216, the motor 310b drives the plate 324 towards the UAV 202. In particular, similar to the first motor 310a that causes the driving rod 316 to move and drive the latch engagement plate 314 toward the UAV 202, the second motor 310b causes a driving rod 326 to move (e.g., spin, extend) and drive the plate 324 toward the UAV 202. In one or more embodiments, driving the plate 324 toward the UAV 202 causes the inner fingers 322 to pivot outward toward the outer fingers 312 and grip an end of the battery assembly 216.

In one or more embodiments, driving the plate 324 toward the first end 304 of the battery arm 302 causes a spreader 328 to push toward the first end 304 of the battery arm 302 between one or more of the inner fingers 322. In particular, as shown in FIGS. 3-4, the battery gripping assembly includes a spreader 328 positioned between each of the inner fingers 322 and which causes the inner fingers 322 to push, pivot, flex, or otherwise move outward from around a central axis of the battery arm 302 when the plate 324 moves toward the first end 304 of the battery arm 302. For example, when the motor 310b drives the plate 324 toward the UAV 202, the plate 324 can push the spreader 328 toward the first end 304 of the battery arm 302 between each of the inner fingers 322. In one or more embodiments, the spreader 328 causes the inner fingers 322 to flex or bend outward from the central axis of the battery 302 when the plate 324 moves towards the first end of the battery arm 302. Alternatively, the spreader 328 can cause the inner fingers 322 to rotate, pivot, or otherwise move outward from the central axis of the battery arm 302.

Additionally, in one or more embodiments, prior to the inner fingers 322 gripping the battery assembly 216, some or all of the battery gripping assembly can move towards the battery assembly 216. In particular, the plate 324 can cause the inner fingers, spreader 328, and sensors 330 to move towards an outer end of the battery assembly 216 facing outward from the UAV 202. Additionally, in one or more embodiments, the sensors 330 of the battery gripping assembly can detect that the battery gripping assembly or other portion of the battery arm 302 is within a predetermined proximity of the battery assembly 216. For example, the sensors 330 can detect that the battery arm 302 is within a proximity of the battery assembly 216 and prevent the battery gripping assembly from coming into contact with the battery assembly 216 and potentially causing damage to the battery assembly 216 and/of the UAV 202.

In addition to preventing the battery gripping assembly from inadvertently coming into contact with and potentially damaging the UAV 202 and/or battery assembly 216, the sensors 330 can further prevent other portions of the battery gripper 302 from damaging the UAV 202. For example, as described above, the battery arm 302 can move towards the UAV 202 into a position such that the outer fingers 312 can rotate inward around a central axis of the battery arm 302 and engage with corresponding latches on the UAV 202. In one or more embodiments, the sensors 330 can determine that the end plate 308 and/or outer fingers 312 are a particular distance from the UAV 202 that would enable the outer fingers 312 to engage a latch on the UAV 202 and unlock the battery assembly 216 from within the UAV 202. Additionally or alternatively, the sensors 330 can detect when other portions of the battery arm 302 are within a proximity of the UAV 202 that could cause the battery arm 302 to inadvertently come into contact with and potentially damage the UAV 202.

Moreover, as shown in FIG. 3, the battery arm 302 includes one or more additional plates 332, 334 positioned at either end of the battery arm 302. For example, the battery arm 302 includes a first end plate 332 towards the first end 304 of the battery arm 302 and a second end plate 334 towards the second end 306 of the battery arm 302. In one or more embodiments, the first end plate 332 is coupled to the second end plate 334 via one or more guide rails 336. The plates 332, 334 and guide rails 336 provide a horizontal structure along which the plates 314, 324 and driving rods 316, 326 can move and cause portions of the battery arm 302 to engage the UAV 202 and/or battery assembly 216. Additionally, as shown in FIG. 3, the battery arm 302 includes a chain 338 that couples an end plate 334 to a driving plate 324. In one or more embodiments, the chain 338 prevents the driving plate 324 from moving more than a length of the chain 338 away from the end plate 334 and coming into contact with and potentially causing damage to other portions of the battery arm 302 and/or the UAV 202.

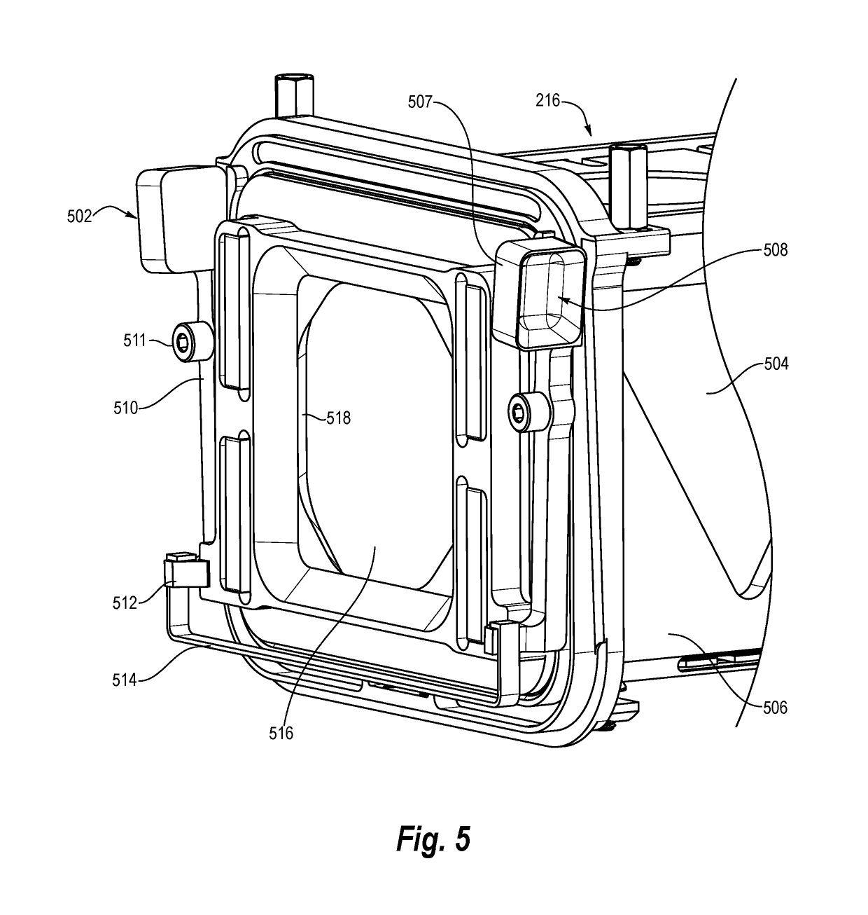

As mentioned above, the battery arm 302 can unlock and remove a battery assembly 216 from within a main housing 204 of a UAV 202. In particular, as shown in FIG. 5, the battery arm 302 can unlock a battery assembly 216 from a UAV 202 by engaging a latch assembly 502 (or simply “latch 502”) on the UAV 202. In particular, in one or more embodiments, the outer fingers 312 of the battery arm 302 can engage a portion of the latch 502 and unlock the battery assembly 216 from within the UAV 202.

As shown in FIG. 5, the battery assembly 216 includes a battery cell 504 within a battery housing 506 inserted and locked within a receiving slot of a UAV 202. In particular, FIG. 5 shows one example of the battery assembly 216 inserted and locked within the main housing 204 of the UAV 202 described above in connection with FIG. 2. Additionally, as shown in FIG. 5, the UAV 202 can include a latch 502 that secures the battery assembly 216 within the receiving slot of the UAV 202. As illustrated in FIG. 5, the latch 506 includes a latch handle 507 (or simply “handle 507”), opening 508 of the handle 507, latch arm 510, pivot 511, lock 512, and latch spring 514. In one or more embodiments, the latch 502 includes an assembly that is part of the main housing 204 of the UAV 202. Alternatively, the latch 502 can include a separate assembly that attaches to or otherwise couples to the main housing 204 of the UAV 202.

As mentioned above, the latch 502 can secure the battery assembly 216 within the UAV 202. In particular, as shown in FIG. 5, a portion of the latch 502 can overlap an opening of the receiving slot of the UAV 202 and prevent the battery assembly 216 from sliding out from the UAV 202. More specifically, in one or more embodiments, the locks 512 of the latch 507 overlap a portion of the opening of the receiving slot thus overlapping a portion of the battery housing 506. As such, where a non-impeded battery assembly 216 would slide out from the UAV 202, the locks 512 provide a structure that prevents the battery assembly 216 from sliding out from the UAV 202 unimpeded.

While the locks 512 provide a structure that prevents the battery assembly 216 from sliding out from the UAV 202 unimpeded, the locks 512 also enable the battery assembly 216 to conveniently slide into the UAV 202 (e.g., without engaging the handles 507). In particular, as shown in FIG. 5 the latch 502 includes a latch spring 514 that connects the locks 512 on either side of the opening to the receiving slot. As such, when outward pressure is applied to the locks 512, the latch spring 514 moves, expands, or otherwise enables the locks 512 to move outward and allow the battery assembly 216 to slide into the opening of the UAV 202.

In one or more embodiments, the locks 512 have a slanted or tapered shape that enables the battery assembly 216 to apply outward force to the locks 512 when the battery assembly 216 slides into the UAV 202. In particular, in one or more embodiments, the locks 512 slant inward such that when the battery assembly 216 makes contact with the locks 512 and moves toward the opening of the UAV 202, an outward force is applied to the locks 512 that causes the latch spring 514 and the locks 512 to move outward. Additionally, once the battery assembly 216 is inserted within the UAV 202, the locks 512 and latch spring 514 automatically return to an equilibrium position with the locks 512 overlapping a portion of the opening of the receiving slot and preventing the battery assembly 216 from sliding out from the UAV 202.

In addition to locking the battery assembly 216 within the UAV 202, the latch 502 can further enable the battery arm 302 to conveniently unlock the battery assembly 216 by engaging the latch handles 507. For example, as shown in FIG. 5, the handles 507 couple to the locks 512 via a latch arm 510 between each handle 507 and lock 512. Additionally, as shown in FIG. 5, the latch 502 includes a pivot 511 around which the latch arm 510 can rotate. As such, when an inward force is applied on each of the latch handles 507, the latch handles 507 move inward around the latch pivot 511 and cause the locks 512 to move outward around the latch pivot 511 until the locks 512 no longer obstruct the receiving slot of the UAV 202. When the locks 512 no longer obstruct the receiving slot of the UAV 202, the battery assembly 216 can slide out from the UAV 202 unobstructed.

In one or more embodiments, the battery arm 302 unlocks the battery assembly 216 by engaging the latch openings 508 of the latch handles 507. In particular, the battery arm 302 can engage the latch openings 508 and apply a force to each of the latch handles 507 that causes the battery assembly 216 to unlock from within the UAV 202. As an example, the outer fingers 312 of the battery arm 302 can fit within the latch openings 508 and push inward on the latch handles 507 causing each of the latch handles 507 to move towards each other (e.g., inward around a central axis of the battery assembly 216). More specifically, the outer fingers 312 can push inward on the latch handles 507 and cause the latch arms 510 to pivot around the latch pivots 511. As the latch handles 507 move inward around the latch pivots 511, the locks 512 move outward from each other (e.g., outward from the central axis of the battery assembly 216) and rotate around the latch pivots 511. As such, by applying the inward force on the latch handles 507, the locks 512 can move outward and remove the obstruction securing the battery assembly 216 in place within the UAV 202.

Once unlocked, the battery arm 302 can further remove the battery assembly 216 from within the UAV 202 by engaging a portion of the battery assembly 216. As shown in

FIG. 5, the battery assembly 216 includes an outer end 516 facing outward form the UAV 202. Additionally, as shown in FIG. 5, the outer end 516 of the battery assembly 216 includes an inner lip around one or more edges of the outer end 516. In one or more embodiments, the battery arm 302 can remove the battery assembly 216 by engaging the outer end 516 and one or more inner lips 518 of the outer end 516 of the battery assembly 216.

For example, once the battery assembly 216 is unlocked, a portion of the battery gripping assembly of the battery arm 302 can move towards the outer end 516 and cause a portion of the battery arm 302 to come into contact with the outer end 516. In one or more embodiments, the inner fingers 322 of the battery arm 302 come into contact with the battery end 516. Additionally, upon making contact with or coming within a predetermined proximity to the outer end 516, the inner fingers 322 can engage the inner lip(s) 518 of the outer end 516 and attach, hook, or otherwise grip the battery assembly 216 by the inner lip 518. For example, as described above, when the inner fingers 322 are in position relative to the inner lip 518, the spreader 328 of the battery arm 302 can cause the inner fingers 322 to move outward and grip each of the inner lips 518 of the outer end 516 of the battery assembly 216.

Once the battery arm 302 has gripped the inner lips 518 of the battery assembly 216, the battery arm 302 can retract and cause the battery assembly 216 to slide out from the main housing 204 of the UAV 202. In particular, one or more of the motors 310 of the battery arm 302 can cause one or more portions of the battery arm 302 to retract. For example, in one or more embodiments, the motor 310b coupled to the battery gripping assembly can cause the battery gripping assembly to retract and remove the battery assembly 216 from the UAV 202. Additionally, while the motor 310b causes the battery gripping assembly to retract, the latch engagement assembly (e.g., the outer fingers 312) can remain engaged with the latch 502 and disengage after the battery assembly 216 has been removed from the UAV 202.

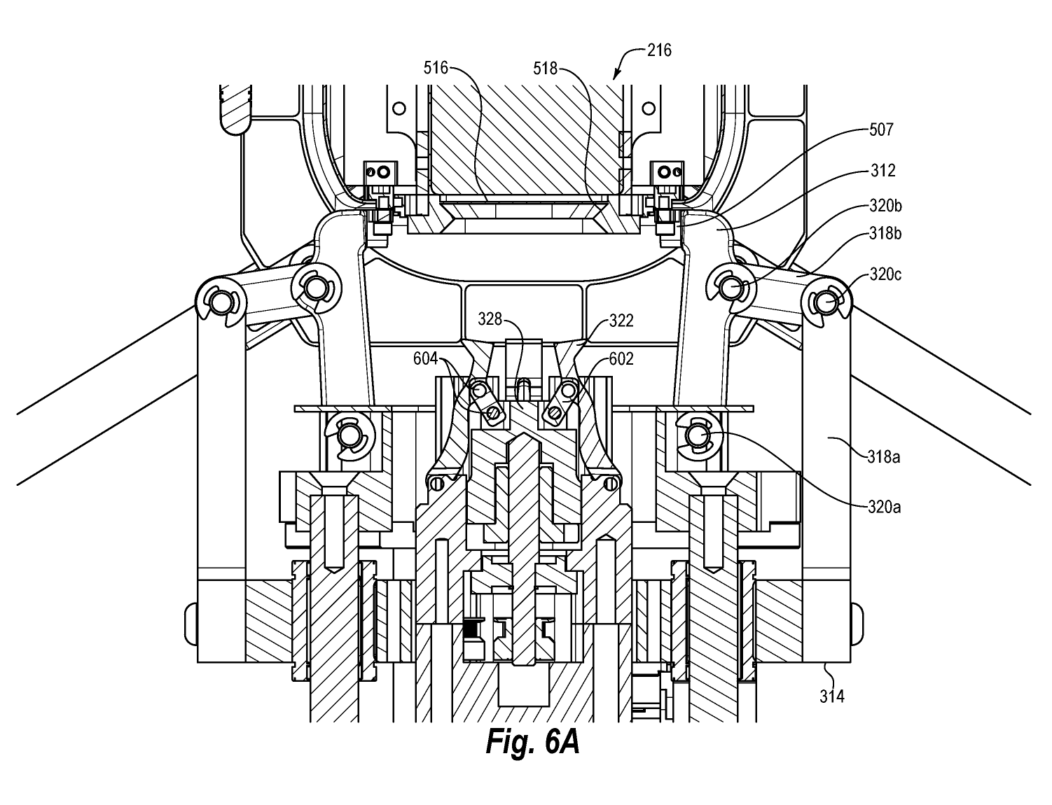

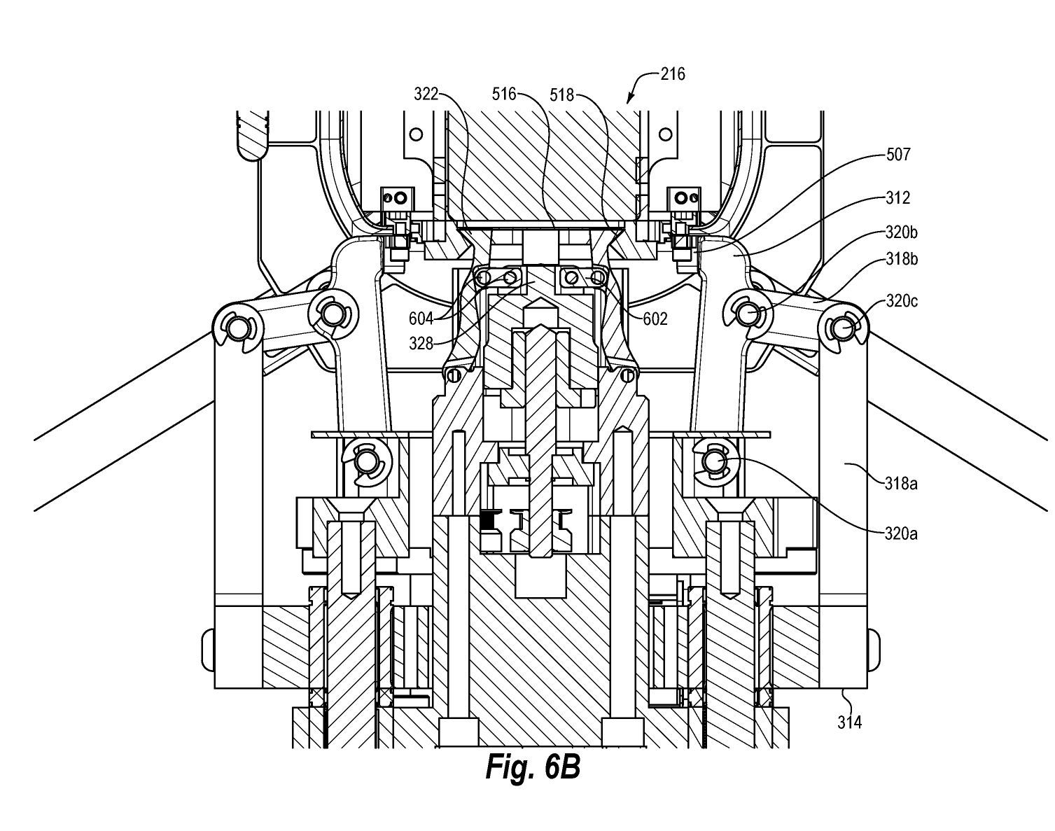

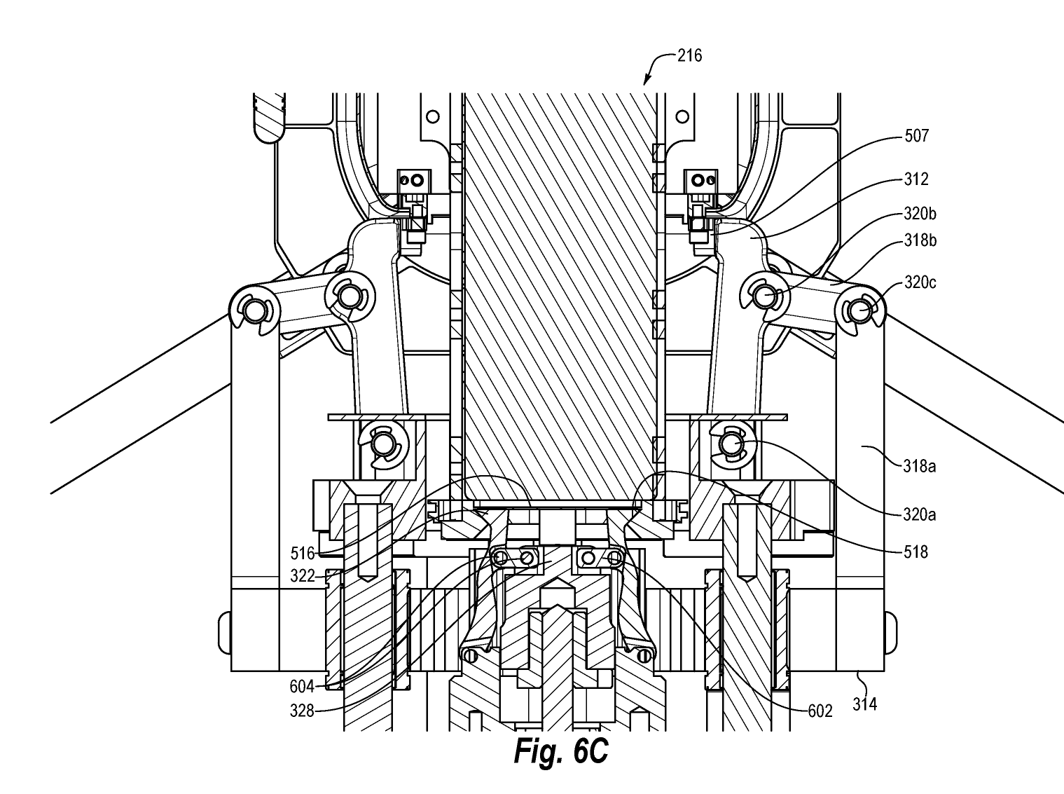

As mentioned above, the battery arm 302 can engage with the UAV 202 to unlock the battery assembly 216 from within the UAV 202. For example, FIG. 6A illustrates an example embodiment of a battery arm 302 unlocking a battery assembly 216 from within the UAV 202. In particular, FIG. 6A shows a top cross-sectional view of one example embodiment in which the latch engagement assembly engages a latch 502 of the UAV 202 to unlock the battery assembly 216 from within the UAV 202.

For example, as shown in FIG. 6A, the outer fingers 312 rotate about a plurality of pivot points 320a-c and engage a handle 507 of the latch 502. In particular, when the drive plate 314 moves towards the UAV 202, the outer fingers 312 rotate about the first pivot point 320a from an initial perpendicular position to the battery assembly 216 to a parallel position relative to the battery assembly 216, as shown in FIG. 6A. While the outer fingers 312 rotate about the first pivot point, a first link 318a between the plate 314 and the outer fingers 312 moves towards the battery assembly 216 causing a second link 318b between the first link 318 and the outer finger 312 to pivot about a second pivot point. Additionally, when the outer fingers 312 approach the handle 507 and fit within the opening 508 of the handle 507, the second link 318b can pivot about the third pivot point 320c as the outer fingers 312 fit within the opening 508 and engage the latch 502.

Additionally, as described above, the outer fingers 312 can unlock the battery assembly 216 from within the UAV 202 by applying inward force on the handles 507 and causing one or more locks 512 to bend, pivot, or otherwise move outward and disengage from a position that prevents the battery assembly 216 from sliding out from the UAV 202. Further, as shown in FIG. 6A, once the outer fingers 312 are engaged, the battery arm 302 incudes a gap between the outer arms 312 that enables an additional portion of the battery arm 302 (e.g., the battery gripping assembly) to move towards the battery assembly 216 between each of the outer arms 312.

As mentioned above, once the battery assembly 216 is unlocked, the battery arm 302 can further engage the battery assembly 216 by gripping a portion of an outer end 516 of the battery assembly 216. For example, as shown in FIG. 6B, the battery gripping assembly can engage the battery assembly 216 by moving towards the battery assembly 216 and coming into contact with the outer end 516. As mentioned above, in one or more embodiments, the battery arm 302 includes one or more sensors 330 that detect that a portion of the battery arm 302 (e.g., the inner fingers 322) have made contact with or are within a threshold proximity of the outer end 516 of the battery assembly 216. As such, the sensors 330 can prevent the battery arm 302 from inadvertently damaging or causing excessive wear and tear on the battery assembly 216 and/or UAV 202.

Once the inner fingers 322 come into contact with the outer end 516, the battery arm 302 can cause the inner fingers 322 to grip an inner lip 518 of the outer end 516 of the battery assembly 216. For example, as shown in FIG. 6B, the battery arm 302 includes a spreader 328 that moves towards the battery assembly 216 and causes the inner fingers 322 to move outward and grip the inner lips 518 of the outer end 516 of the battery assembly 216. In one or more embodiments, the spreader 328 couples to the inner fingers 322 via one or more links 602 that pivot around one or more pivot points 604 as the spreader 328 moves towards the battery assembly 216.

In one or more embodiments, the battery arm 302 can cause a portion of the outer end 516 to compress when the inner fingers 322 or other portion of the battery arm 302 comes into contact with and applies a force on the outer end 516 of the battery assembly 216. For example, after the inner fingers 322 come into contact with the outer end 516 of the battery assembly 216, the outer end 516 can compress into the opening of the receiving port of the UAV 202. When the outer end 516 compresses, the spreader 328 can cause the inner fingers 322 to move outward and grip the inner lips 518 that are made available via the compression of the outer end 516.

While the battery arm 302 grips the unlocked battery assembly 216, the battery arm 302 can retract and remove the battery assembly 216 from the UAV 202. For example, as shown in FIG. 6C, the battery gripping assembly can retract or otherwise move away from the UAV 202 and cause the battery assembly 216 to slide out from the UAV 202. In one or more embodiments, the latch engagement assembly continues to engage the UAV 202 while the battery gripping assembly removes the battery assembly 216 from within the UAV 202. For example, as shown in FIG. 6C, the outer fingers 322 remain engaged with the latch handles 507 to remove the obstruction of the locks 512 while the battery assembly 216 slides out from the UAV 202. The latch engagement assembly can disengage from the latch 502 once the battery assembly 216 is removed and the battery arm 302 can retract within the UAVGS 102.

Additionally, the battery arm 302 can further store the removed battery assembly 216 within the UAVGS 102 and place a new (e.g., charged) battery within the receiving slot of the UAV 202. For example, upon storing the removed battery assembly 216 within the UAVGS 102, the battery arm 302 can move within the UAVGS 102 and retrieve a new battery using a similar or different process as removing the battery assembly 216 from within the UAV 202. The battery arm 302 can further align with the receiving slot of the UAV 202 and insert the new battery within the UAV 202 to enable the UAV 202 to take off, fly, and land with a full battery.

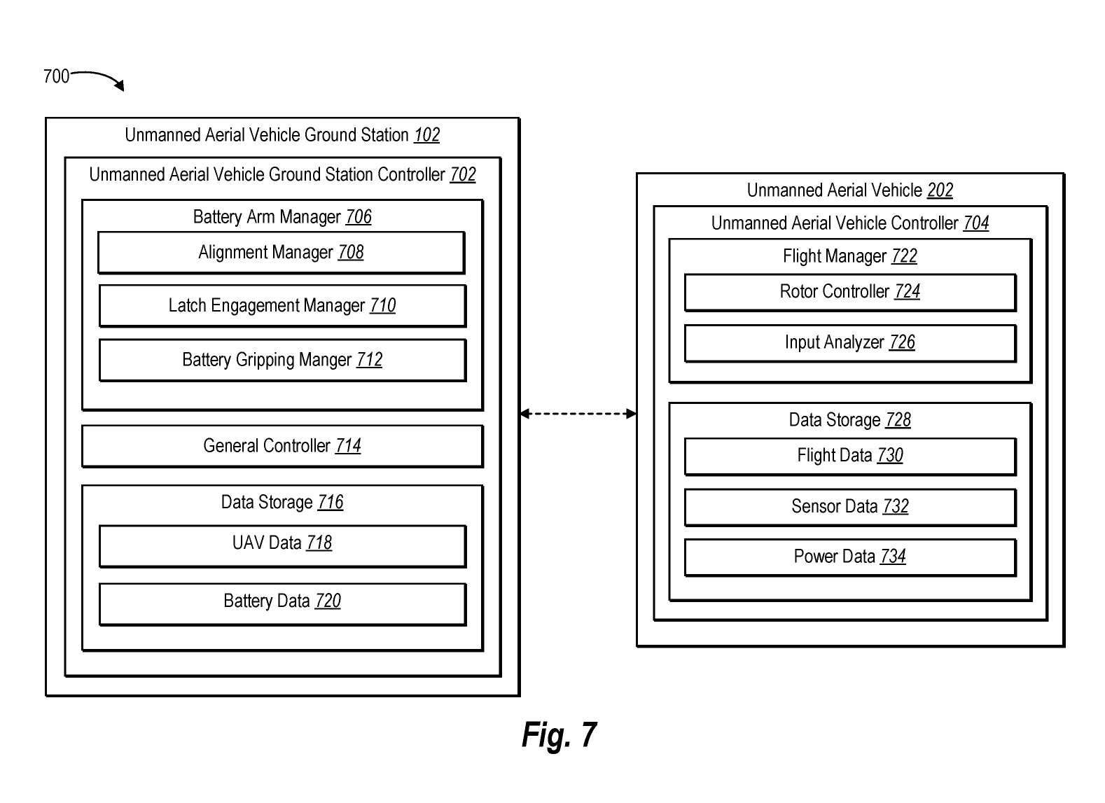

FIG. 7 illustrates a schematic diagram showing an example embodiment of an autonomous landing system 700 (or simply “system 700”) within which various embodiments of battery arms described herein may be implanted. As shown in FIG. 7, the system 700 may include various components for performing the processes and features described herein. For example, as shown in FIG. 7, the system 700 includes, but is not limited to, an unmanned aerial vehicle ground station 102 (or simply “UAVGS 102”) and an unmanned aerial vehicle 202 (or simply “UAV 202”). As shown in FIG. 7, the UAVGS 102 can include a UAVGS controller 702, which in turn can include, but is not limited to, a battery arm manager 706 including an alignment manager 708, latch engagement manager 710, and a battery gripping manager 712. Additionally, the UAVGS controller 702 can include a general controller 714 and data storage 716 including UAV data 718 and battery date 720. Further, as shown in FIG. 7, the UAV controller 704 can include, but it not limited to, a flight manager 722 including a rotor controller 724 and an input analyzer 726. Additionally, the UAV controller 704 can include a data storage 728 including flight data 730, sensor data 732, and power data 734.

Each of the components 706-720 of the UAVGS controller 702, and the components 722-734 of the UAV controller 704 can be implemented using a computing device including at least one processor executing instructions that cause the system 700 to perform the processes described herein. In some embodiments, the components 706-720 and 722-734 can comprise hardware, such as a special-purpose processing device to perform a certain function. Additionally, or alternatively, the components 706-720 and 722-734 can comprise a combination of computer-executable instructions and hardware. For instance, in one or more embodiments the UAV 202 and/or the UAVGS 102 include one or more computing devices, such as the computing device described below with reference to FIG. 9. In one or more embodiments, the UAVGS controller 702 and the UAV controller 704 can be native/local applications installed on the UAVGS 102 and the UAV 202, respectively. In some embodiments, the UAVGS controller 702 and the UAV controller 704 can be remotely accessible over a wireless network.

Additionally, while FIG. 7 illustrates a UAVGS controller 702 having components 706-720 located thereon, it is appreciated that the UAV controller 704 can include similar components having features and functionality described herein with regard to the UAVGS controller 702. Similarly, while FIG. 7 illustrates a UAV controller 704 having components 722-734 located thereon, it is appreciated that the UAVGS controller 702 can include similar components having features and functionality described herein with regard to the UAV controller 704. As such, one or more features described herein with regard to the UAVGS controller 702 or the UAV controller 704 can similarly apply to both the UAVGS controller 702 and/or the UAV controller 704.

As described above, the system 700 includes components across both the UAVGS 102 and the UAV 202 that enable the UAV 202 to autonomously land on the UAVGS 102 and for the UAVGS 102 to replace a battery on board the UAV 202. Accordingly, the system 100 includes various components that enable a battery arm 302 on board the UAVGS 102 to replace a battery assembly 216 when the UAV 202 is landed without any external intervention (e.g., without an operator remotely controlling the UAVGS 102 and/or UAV 202 during the battery removal process). Additionally, the UAVGS 102 can cause a battery arm 302 to perform a multi-stage engagement process with respect to removing the battery assembly 216 and/or storing the battery assembly 216 on board the UAVGS 102 autonomously without assistance from a remote operator and without causing substantial wear and tear on the UAV 202.

As mentioned above and as illustrated in FIG. 7, the UAVGS controller 702 includes a battery arm manager 706 that controls various functions of a battery arm 302 on board the UAVGS 102. As shown in FIG. 7, the battery arm manager 706 includes an alignment manager 708 that controls a position of the battery arm 302 with respect to a landed UAV 202. For example, the alignment manager 708 can cause the battery arm 302 to rotate, shift, or otherwise move within a housing 104 of the UAVGS 102 such that an end of the battery arm 302 aligns with respect to the battery assembly 216 within the UAV 202.

In addition to, or as an alternative to, causing the battery arm 302 to move within the UAVGS 102 with respect to the UAV 202, one or more embodiments of the alignment manager 708 cause one or more components of the UAVGS 102 and/or UAV 202 to move with respect to the battery arm 302. For example, in one or more embodiments, the alignment manager 708 controls movement of a landing housing 110 of the UAVGS 102 and causes a floor of the landing housing 110 and/or an opening 112 of the landing housing 110 to rotate such that a receiving slot of the UAV 202 lines up with the battery arm 302. Additionally, in one or more embodiments, the alignment manager 708 can control movement of the battery arm 302, landing housing 110, floor of the landing housing 110, and/or the UAV 202 based on one or more sensor inputs from sensors on the UAVGS 102 (e.g., on the battery arm 302 of the UAVGS 102) and/or UAV 202.

In addition to the alignment manager 708, the battery arm manager 706 includes a latch engagement manager 710 that controls engagement of the UAV 202 using a portion of the battery arm 302. For example, once the battery arm 302 is aligned with respect to the UAV 202, the latch engagement manager 710 can cause a latch engagement assembly of the battery arm 302 to move towards the UAV 202 and engage one or more latches of the UAV 202. Additionally, engaging the UAV 202 can cause the battery assembly 216 within the UAV 202 to unlock such that the battery assembly 216 can slide out from a receiving slot of the UAV 202.

In one or more embodiments, the latch engagement manager 710 causes the battery assembly 216 to unlock by applying a force on one or more latch handles 507 and removing one or more obstructions (e.g., latch locks 512) that prevent the battery assembly 216 to slide out from the UAV 202. For example, the latch engagement manager 710 can cause outer fingers 312 to rotate around one or more pivot points, engage the latch handles 507, and unlock the battery assembly 216 from within the UAV 202.

As shown in FIG. 7, the battery arm manager 706 further includes a battery gripping manager 712 that causes the battery arm 302 to grip a portion of the battery assembly 216 and/or UAV 202 and remove the unlocked battery assembly 216 from the UAV 202. For example, the battery gripping manager 712 can control movement of one or more inner fingers 322 that grip an outer end 516 of the battery assembly 216. Additionally, the battery gripping manager 712 can cause a portion of the battery arm 302 to retract and remove the battery assembly 216 from within the UAV 202.

Moreover, while not shown in FIG. 7, the battery arm manager 706 can further control movement of the battery arm 302 to store a removed battery assembly 216 and/or replace the removed battery assembly 216 with a new (e.g., charged) battery. For example, the battery arm manager 706 can cause the battery arm 302 to rotate and/or move within the UAVGS 102 and place the removed battery assembly 216 within a charging slot within the UAVGS 102. Additionally, in one or more embodiments, the battery arm manager 706 can cause the battery arm 302 to grip a new battery and place the new battery within the UAV 202.

In addition to the battery arm manager 706, the UAVGS controller 702 further includes a general controller 714. In one or more embodiments, the general controller 714 can handle general system tasks including, for example, battery charging, data storage, UAV docking, receiving and processing user input, etc. As an example, after the UAV 202 autonomously lands on the UAVGS 102, the general controller 714 can manage receiving and processing user input with regard to recharging a battery while the UAV 202 is landed. As another example, in one or more embodiments, the general controller 714 can manage downloading or transferring data collected by the UAV 202 (e.g., during a previous flight). Additionally, in one or more embodiments, the general controller 714 can control transmission, receiving, and processing various signals received from the UAV 202.

Furthermore, as mentioned above, and as illustrated in FIG. 7, the UAVGS controller 702 also includes a data storage 716. As shown, the data storage 716 can include UAV data 718 and battery data 720. In particular, the UAV data can include data representative of information associated with the UAV 202. Additionally, the battery data 720 can include information associated with batteries within the UAV 202 and/or within the UAVGS 102. For example, the battery data 720 can include information about battery life, charge capacity, voltage and current specifications and other information associated with batteries within the UAV 202 and/or UAVGS 102.

As shown in FIG. 7, the UAV controller 704 includes a flight manager 722. In one or more embodiments, and in order for the UAV 202 to autonomously land on the UAVGS 102, the flight manager 722 can control all of the mechanical flight elements associated with the UAV 202 (e.g., motors, rotor arms, rotors, landing gear, etc.). For example, in at least one embodiment, the flight manager 722 can receive input from one or more sensors on the UAV 202 and/or UAVGS 102. The flight manager 722 can then control various mechanical features of the UAV 202 based on the received inputs in order to autonomously land the UAV 202 on the UAVGS 102.

As illustrated in FIG. 7, the flight manager 722 includes a rotor controller 724. In one or more embodiments, the rotor controller 724 controls the speed of one or more rotors associated with the UAV 202. Accordingly, by controlling the speed of the rotors, the rotor controller 724 can cause the UAV 202 to travel up and down vertically. Further, by controlling the speed of the rotors, the rotor controller 724 can cause the UAV to travel back and forth, and side to side horizontally. Thus it follows that, by controlling the speed of one or more rotors associated with the UAV 202, the rotor controller 724 can cause the UAV 202 to travel anywhere within an uninhibited three-dimensional space.

Also as illustrated in FIG. 7, the flight manager 722 includes an input analyzer 726. In one or more embodiments, the input analyzer 726 analyzes the data or inputs received in order to determine a position of the UAV 202. For example, in one embodiment, the input analyzer 726 can analyze digital photographs or video provided by a camera on the UAV 202 to determine whether the UAV 202 is located in a position above the UAVGS 102. In another example, the input analyzer 726 can analyze energy sensor readings of an energy wave to determine how far above the UAVGS 102 the UAV 202 is located (e.g., the altitude of the UAV 202). The input analyzer 726 can utilize algorithms, lookup tables, etc. in order to determine the UAV's 202 position based on inputs received from the UAVGS 102 and/or other components within the UAV 202. Additionally, in at least embodiment, the input analyzer 726 can receive inputs from a global position system associated with the UAV 202 in order to determine the UAV's 202 position.

Furthermore, as mentioned above, and as illustrated in FIG. 7, the UAV controller 704 also includes a data storage 728. As shown, the data storage 728 can include flight data 730 and sensor data 732. In one or more embodiments, the flight data 730 can include data representative of the UAV's 202 flight, such as described herein (e.g., GPS information, camera information, etc.). Similarly, in one or more embodiments, the sensor data 732 can include data representative of information gathered by one or more sensors located on the UAV 202 and/or UAVGS 102. Additionally, in one or more embodiments, the data storage 728 can include power data 734. The power data 734 can include data representative of power information associated with a battery and/or one or more power systems on board the UAV 202. For example, the power data 734 can include a battery level, a remaining life of a battery, or a time for the battery on board the UAV 202 to recharge when docked within the UAVGS 102.

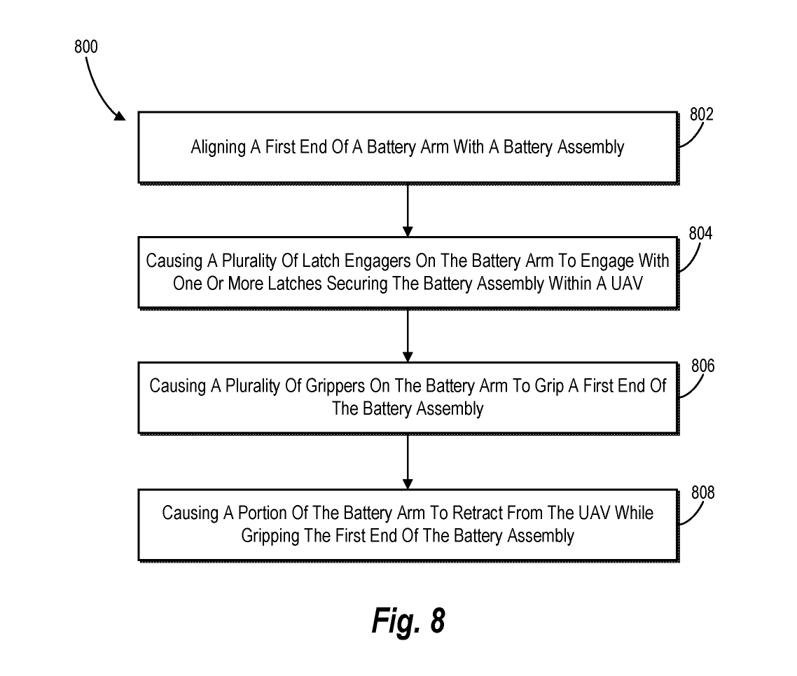

FIGS. 1-7, the corresponding text, and the above-discussed examples provide a number of different methods, systems, and devices for replacing a battery assembly 216 from within a UAV 202. In addition to the foregoing, embodiments can also be described in terms of flowcharts comprising acts and steps in a method for accomplishing a particular result. For example, FIG. 8 may be performed with less or more steps/acts or the steps/acts may be performed in differing orders. Additionally, the steps/acts described herein may be repeated or performed in parallel with one another or in parallel with different instances of the same or similar steps/acts

FIG. 8 illustrates a flowchart of one example method 800. For example, the method 800 can include a method of removing a battery from within a UAV 202 while the UAV 202 is landed within a UAVGS 102. In one or more embodiments, each step of the method 800 is performed by a UAVGS 102 including a battery arm 302. Additionally, or alternatively, the UAV 202 can perform one or more steps of the method 800. In one or more embodiments, the UAVGS 102 and/or UAV 202 performs one or more steps in accordance with computer-executable instructions and hardware installed on the UAVGS 102 and/or UAV 202.

As shown in FIG. 8, the method 800 includes a process for removing a battery assembly 216 from within a UAV 202. For example, as shown in FIG. 8, the method 800 includes an act 802 of aligning a first end 304 of a battery arm 302 with a battery assembly 216. In one or more embodiments, aligning the first end 304 of the battery arm 302 involves aligning the first end 304 of the battery arm 304 with an opening 112 in the landing housing 110 of a UAVGS 102. Additionally, aligning the first end 304 of the battery arm 302 can involve moving the battery arm 304 within the UAVGS 102 to line up with a receiving slot of a UAV 202 landed within the UAVGS 102. Further, in one or more embodiments, aligning the first end 304 of the battery arm 302 involves moving (e.g., rotating) the UAV 202 or portion of the landing housing 110 to line up the battery assembly 216 within the UAV 202 with the first end 304 of the battery arm 302. Additionally, in one or more embodiments, aligning the first end 304 of the battery arm 302 with the battery assembly 216 involves moving the battery arm 302 within a proximity of the battery assembly 216 such that a latch engagement assembly and/or a battery gripping assembly are in a position to engage with the UAV 202 and/or battery assembly 216 within the UAV 202.

The method 800 also include an act 804 of causing a plurality of latch engagers on the battery arm 302 to engage with one or more latches 502 securing the battery assembly 216 within the UAV 202. In one or more embodiments, causing the plurality of latch engagers to engage with one or more latches 502 involves unlocking the battery assembly 216 from within the UAV 202 by engaging a latch 502 on the UAV 202. In particular, causing the plurality of latch engagers to engage the latch assembly 502 can involve causing the plurality of latch engagers (e.g., outer fingers 312) to pivot, rotate, flex, or otherwise move inward to engage openings 508 of handles 507 of the latch 502. In one or more embodiments, engaging the latch handles 507 causes an arm 510 of the latch 502 to pivot around a latch pivot 511 and cause the battery assembly 216 to unlock from within the UAV 202.

The method 800 also includes an act 806 of causing a plurality of grippers on the battery arm 302 to grip a first end of the battery assembly 216. In one or more embodiments, causing the plurality of grippers on the battery arm 302 to grip the first end of the battery assembly 216 involves causing a portion of the battery arm 302 (e.g., the battery gripping assembly) to move towards the battery assembly 216 and come into contact with an outer end 516 of the battery assembly 216. For example, causing the plurality of grippers on the battery arm 302 to grip the first end of the battery assembly 216 can involve causing the plurality of grippers (e.g., inner fingers 322) to come into contact with the outer end 516 and gripping one or more inner lips 518 of the outer end 516 of the battery assembly 216. In one or more embodiments, causing the plurality of grippers on the battery arm 302 to grip the first end of the battery assembly 216 involves causing the plurality of grippers to rotate, pivot, flex, or otherwise move outward around the central axis of the battery arm 302 and grip a portion of the battery assembly 302.

The method 800 also includes an act 808 of causing a portion of the battery arm 302 to retract from the UAV 202 while gripping the first end of the battery assembly 216. In one or more embodiments, causing the portion of the battery arm 302 to retract from the UAV 202 while gripping the first end of the battery assembly 216 involves causing the battery gripping assembly to move away from the UAV 202 and slide the battery assembly 216 out from the UAV 202 as the battery gripping assembly moves away from the UAV 202. Additionally, in one or more embodiments, causing the portion of the battery arm 302 to retract from the UAV 202 while gripping the first end of the battery assembly 216 involves causing the portion of the battery arm 302 to retract while both the latch engagement assembly is engaging the latch 502 of the UAV 202 and the battery gripping assembly is gripping the outer end 516 of the battery assembly 216.

Additionally, while not shown in FIG. 8, the method 800 can further include acts of disengaging from the UAV 202 and/or battery assembly 216. For example, once the battery assembly 216 is removed from the UAV 202, the battery arm 302 can disengage from the UAV 202 by causing the latch engagers (e.g., outer fingers 312) to rotate, flex, pivot, or otherwise move outward from the central axis of the battery arm 302 and disengaging the handles 507 of the latch 502. Additionally, the method 800 can include causing the battery arm 302 to store the battery assembly 216 within the UAVGS 102. Once stored, the battery arm 302 can disengage from the battery assembly 216 by causing the battery grippers (e.g., inner fingers 322) to rotate, flex, pivot, or otherwise move inward toward the central axis of the battery arm 302 and disengage from the outer end 516 of the battery assembly 216. In addition, the method 800 can further include causing the battery arm 302 to grip a new battery (e.g., a charged battery) stored within the UAVGS 102 and replace the removed battery with the new battery. In one or more embodiments, gripping the new battery involves similar steps as described above in unlocking and/or gripping an end of the battery assembly 216 described above.

Further, in one or more embodiments, the method 800 includes receiving a user input instructing the UAVGS 102 and/or battery arm 302 to perform one or more of the steps of the method 800. Additionally, or alternatively, the method 800 may include receiving an input that indicates that the battery assembly 216 should be replaced and performing each of the steps 800 of the method in response to receiving the input.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) could be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, watches, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 9 illustrates a block diagram of exemplary computing device 900 that may be configured to perform one or more of the processes described above (e.g., as described in connection with the UAV 202 or UAVGS 102). As an example, the exemplary computing device 900 can be configured to perform a process for removing and/or replacing a battery assembly 216 within a UAV 202. Additionally, the computing device 900 can be programmed to perform one or more steps of the method 800 described above in connection with FIG. 8. As shown by FIG. 9, the computing device 900 can comprise a processor 902, a memory 904, a storage device 906, an I/O interface 908, and a communication interface 910, which may be communicatively coupled by way of a communication infrastructure 912. While an exemplary computing device 900 is shown in FIG. 9, the components illustrated in FIG. 9 are not intended to be limiting. Additional or alternative components may be used in other embodiments. Furthermore, in certain embodiments, the computing device 900 can include fewer components than those shown in FIG. 9. Components of the computing device 900 shown in FIG. 9 will now be described in additional detail.

In one or more embodiments, the processor 902 includes hardware for executing instructions, such as those making up a computer program. As an example and not by way of limitation, to execute instructions, the processor 902 may retrieve (or fetch) the instructions from an internal register, an internal cache, the memory 904, or the storage device 906 and decode and execute them. In one or more embodiments, the processor 902 may include one or more internal caches for data, instructions, or addresses. As an example and not by way of limitation, the processor 902 may include one or more instruction caches, one or more data caches, and one or more translation lookaside buffers (TLBs). Instructions in the instruction caches may be copies of instructions in the memory 904 or the storage 906.

The memory 904 may be used for storing data, metadata, and programs for execution by the processor(s). The memory 904 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 904 may be internal or distributed memory.

The storage device 906 includes storage for storing data or instructions. As an example and not by way of limitation, storage device 906 can comprise a non-transitory storage medium described above. The storage device 906 may include a hard disk drive (“HDD”), a floppy disk drive, flash memory, an optical disc, a magneto-optical disc, magnetic tape, or a Universal Serial Bus (“USB”) drive or a combination of two or more of these. The storage device 906 may include removable or non-removable (or fixed) media, where appropriate. The storage device 906 may be internal or external to the computing device 900. In one or more embodiments, the storage device 906 is non-volatile, solid-state memory. In other embodiments, the storage device 906 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 908 allows a user to provide input to, receive output from, and otherwise transfer data to and receive data from computing device 900. The I/O interface 908 may include a mouse, a keypad or a keyboard, a touch screen, a camera, an optical scanner, network interface, modem, other known I/O devices or a combination of such I/O interfaces. The I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data may be representative of one or more graphical user interfaces and/or any other graphical content as may serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example and not by way of limitation, the communication interface 910 may include a network interface controller (“NIC”) or network adapter for communicating with an Ethernet or other wire-based network or a wireless NIC (“WNIC”) or wireless adapter for communicating with a wireless network, such as a WI-FI.

Additionally or alternatively, the communication interface 910 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 910 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 912 may include hardware, software, or both that couples components of the computing device 900 to each other. As an example and not by way of limitation, the communication infrastructure 912 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A system comprising:
an unmanned aerial vehicle (UAV) comprising:
a main body; and
a battery assembly locked within the main body of the UAV via at least one latch; and
an unmanned aerial vehicle ground station (UAVGS) comprising:
a landing housing that receives the UAV when the UAV lands within the UAVGS; and
a battery arm that selectively engages the battery assembly, the battery arm comprising:
a latch engagement assembly that unlocks the battery assembly by engaging the at least one latch; and
a battery gripping assembly that grips a portion of the battery assembly and allows the battery arm to retract the battery assembly from the UAV.

2. The system as recited in claim 1, wherein a portion of the landing housing rotates to align an opening in the landing housing with the battery arm.

3. The system as recited in claim 1, wherein the landing housing has a conical shape with an opening in a wall of the landing housing, the opening having a position that is horizontal from the battery arm within the UAVGS when the opening is aligned with the battery arm.

4. A battery arm, comprising:
a latch engagement assembly, comprising:
a plurality of latch engagers sized to engage one or more latches on an unmanned aerial vehicle (UAV) that retains a battery assembly to the UAV; and
a first actuator that causes the plurality of latch engagers to pivot inward about a first end of the battery arm and engage the one or more latches; and
a battery gripping assembly comprising:
a plurality of battery grippers positioned inward from the plurality of latch engagers; and
a second actuator that causes the plurality of battery grippers to grip a portion of the battery assembly to allow for retraction of the battery assembly from the UAV.

5. The battery arm as recited in claim 4, further comprising a first plate coupled to the plurality of latch engagers and the first actuator.

6. The battery arm as recited in claim 5, wherein the first actuator causes the plurality of latch engagers to pivot inward about the first end of the battery arm by driving the first plate toward the first end of the battery arm.

7. The battery as recited in claim 6, wherein driving the first plate toward the first end of the battery arm further causes the plurality of latch engagers to unlock the battery assembly from within a receiving slot of the UAV.

8. The battery arm as recited in claim 5, further comprising a second plate coupled to the plurality of battery grippers.

9. The battery arm as recited in claim 8, wherein the second actuator causes the plurality of battery retainers to grip the portion of the battery assembly by driving the second driving plate toward the first end of the battery arm.

10. The battery arm as recited in claim 9, wherein the second actuator causes the plurality of battery retainers to pivot outward toward the plurality of latch engagers an outer end of the battery assembly to allow for retraction of the battery assembly from the UAV.

11. The battery arm as recited in claim 4, wherein the battery gripping assembly further comprises a spreader positioned between each of the plurality of battery grippers.

12. The battery arm as recited in claim 11, wherein the second actuator causes the plurality of battery grippers to grip the portion of the battery assembly by driving the spreader toward the first end of the battery arm, wherein driving the spreader toward the first end of the battery arm causes the plurality of battery retainers to move apart and engage the portion of the battery assembly.

13. The battery arm as recited in claim 4, wherein the battery arm further comprises one or more sensors that detect a distance between the battery arm and the battery assembly.

14. The battery arm as recited in claim 13, wherein the one or more sensors comprise one or more proximity sensors that measure a distance between the plurality of battery grippers and the battery assembly.

15. The battery arm as recited in claim 4, wherein the second actuator causes the grippers to engage a lip on an outer housing of the battery assembly.

16. The battery arm as recited in claim 4, wherein when the plurality of latch engagers are engaged with the one or more latches and the plurality of battery grippers are gripping the portion of the battery assembly, the second actuator causes the battery gripping assembly to retract from the UAV and remove the battery assembly from within the UAV.

17. The battery arm as recited in claim 4, wherein the plurality of battery grippers grip the portion of the battery assembly while the latch engagers are pivoted inward and engaged to the one or more latches.

18. A method comprising:
aligning, by at least one processor, a first end of a battery arm with a battery assembly within an unmanned aerial vehicle (UAV);
causing, by the at least one processor, a plurality of latch engagers on the battery arm to engage with one or more latches to unlock the battery assembly from the UAV;
causing, by the at least one processor, a plurality of grippers on the battery arm to grip a first end of the battery assembly; and
causing, by the at least one processor, a portion of the battery arm to retract from the UAV while gripping the first end of the battery assembly.

19. The method as recited in claim 18, wherein causing the latch engagers to engage with the one or more latches further comprises causing the plurality of latch engagers to pivot inward around a central axis of the battery arm to engage the one or more latches on the UAV.

20. The method as recited in claim 19, wherein causing the plurality of grippers on the battery arm to grip the first end of the battery assembly further comprises causing the plurality of grippers to move outward around the central axis of the battery arm to grip the first end of the battery assembly.
